(19) United States
(12) Patent Application Publication
(10) Pub. No.: US 2021/0172913 A1
(43) Pub. Date: Jun. 10, 2021

(54) MICRO GAS CHROMATOGRAPHY SYSTEM

(71) Applicant: Nanova Environmental, Inc., Columbia, MO (US)

(72) Inventors: Weicai WANG, Columbia, MO (US); Haisheng ZHENG, Columbia, MO (US); Jun YIN, Columbia, MO (US)

(73) Assignee: Nanova Environmental, Inc., Columbia, MO (US)

(21) Appl. No.: 16/704,697

(22) Filed: Dec. 5, 2019

(51) Int. Cl. G01N 30/30; G01N 1/40

(52) U.S. Cl. CPC G01N 30/30; G01N 2030/025; G01N 1/405

(57) ABSTRACT

A thermal desorption unit includes a tube, an adsorbent material including one material or a combination of several materials disposed inside the tube, holding members disposed inside the tube and configured to hold the adsorbent material in the tube, and a heating wire coiled around the tube and configured to generate heat along the tube. A column module includes a capillary column, a heating wire coiled around the capillary column, a temperature sensor configured to monitor the temperature of the capillary column, and an electrical insulating layer disposed around the capillary column and the heating wire.

### TECHNICAL FIELD

The present disclosure relates generally to a micro gas chromatography system. More specifically, the present disclosure relates to a thermal desorption unit and a column module in a micro gas chromatography system.

### BACKGROUND

The statements in this section merely provide background information related to the present disclosure and may not constitute prior art.

Gas chromatography (GC) is widely used for separating and analyzing fluid compounds. A typical GC system may include a thermal desorption unit (also referred to as a “preconcentrator”) that concentrates a fluid sample, such as a volatile organic compound, a column module that separates the concentrated fluid samples into various fluid components, and a detector that analyzes the various fluid components.

Recently, miniaturized and portable GC systems, such as micro GC systems, have been developed for applications such as on-site environmental monitoring. In these micro GC systems, it is desirable for every component to be compact in size. Developing components that are compact in size can present unique design challenges.

### SUMMARY

According to one aspect of the present disclosure, a thermal desorption unit is provided. The thermal desorption unit includes a tube, an adsorbent material including one material or a combination of several materials disposed inside the tube, holding members disposed inside the tube and configured to hold the adsorbent material in the tube, and a heating wire coiled around the tube and configured to generate heat along the tube.

According to another aspect of the present disclosure, a column module is provided. The column module includes a capillary column, a heating wire coiled around the capillary column, a temperature sensor configured to monitor the temperature of the capillary column, and an electrical insulating layer disposed around the capillary column and the heating wire.

It is to be understood that both the foregoing general description and the following detailed description are exemplary and explanatory only and are not restrictive of the claims.

### BRIEF DESCRIPTION OF THE DRAWINGS

The accompanying drawings, which are incorporated in and constitute a part of this specification, illustrate example embodiments and, together with the description, serve to explain the principles of the embodiments. In the drawings:

FIG. 1A is a schematic illustration of a gas chromatograph (GC) system in a sampling operation, according to one embodiment of the present disclosure.

FIG. 1B a schematic illustration of a GC system in an analyzing operation, according to one embodiment of the present disclosure.

FIG. 2 is a schematic illustration of a thermal desorption unit (TDU), according to some embodiments of the present disclosure.

FIG. 3 is a flow chart of a method of assembling a TDU, according to some embodiments of the present disclosure.

FIGS. 4, 5, and 6 are schematic illustrations of a TDU during various stages of assembly, according to some embodiments of the present disclosure.

FIGS. 7A, 7B, and 7C are schematic illustrations of a column module, according to some embodiments of the present disclosure.

FIGS. 8A and 8B are schematic illustrations of a column module in an assembled state, according to some embodiments of the present disclosure.

FIGS. 9A, 9B, and 9C are schematic illustrations of a two-piece case of a column module, according to some embodiments of the present disclosure.

Corresponding reference numerals indicate corresponding parts throughout the several views of drawings.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations. Instead, they are merely examples of devices and methods consistent with aspects related to the appended claims.

A micro GC system may include a micro thermal desorption unit (TDU) that concentrates a fluid sample, a column module that separates the concentrated fluid samples into various fluid components, and a detector that analyzes the various fluid components.

For example, the micro TDU may collect the fluid sample, such as one or more volatile organic compounds, onto an adsorbent material, while a high vapor pressure gas like oxygen, nitrogen, and carbon dioxide passes through it. After collecting the volatile organic compounds, the micro TDU may be heated by electrical resistive heating and a carrier gas may flow through the micro TDU to release the compounds and concentrate them into a smaller volume.

An increased collection time may be directly correlated to further increased performance of the micro GC. In other words, higher sensitivities may be achieved by collecting target vapors for a longer time in the micro thermal desorption unit.

Traditionally, two types of TDUs are used in a micro GC. A first typical TDU includes a metal or glass tube packed with adsorbent materials and is connected to external heating equipment. In order to analyze volatile organic compounds, the metal or glass tube packed with the adsorbent materials is taken to field sites to collect the analytes. Then the TDU is brought back to a laboratory and connected to external heating equipment to desorb the analytes into a GC system, such as a bench-top GC system. Because the first typical TDU needs to be connected to external heating equipment before analysis is performed using the bench-top GC system, it cannot be used in real-time for on-site (e.g., on the site where the volatile organic compounds to be analyzed) continuous sampling and analysis.

A second typical TDU is formed by microfabrication on a substrate, such as a glass substrate or a silicon wafer. A resistance heater is formed on an opposite side of the substrate. The second typical TDU does not need any external heating equipment before analysis using the bench-top GC system, and therefore it can be used in real-time on-site continuous sampling and analysis. However, the microfabrication of the second typical TDU usually requires special equipment and complicated fabrication process. In addition, the material (glass or silicon wafer) of the substrate is fragile, which impairs the durability of the second typical TDU. A polymer adhesive is used to seal the second typical TDU, but such an adhesive is unreliable and may contaminate the gas line formed in the TDU.

Embodiments of the present disclosure address one or more disadvantages associated with the above-described typical TDUs. According to one embodiment, a compact TDU may include a tube packed with adsorbent materials and a heating wire coiled around the tube. Since the TDU integrates the tube and the heating wire into a compact device, there is no need to connect the TDU to external heating equipment before analysis. As a result, the TDU of the embodiments of the present disclosure may be integrated into a GC system, especially in a portable micro GC system, for on-site continuous sampling and analysis.

According to one embodiment, in the TDU, two gas flow columns may be coupled to opposite ends of the tube, respectively. In addition, two connectors may be disposed around the opposite ends of the tube, respectively, to seal a gap between the tube and the gas flow columns, such that no gas will leak through the gap between the tube and the gas flow columns. Therefore, the TDU according to the embodiments of the present disclosure has a relatively small dead volume. The relatively small dead volume may improve fluidic flow, thereby making the signal peak much sharper than those devices using conventional tube preconcentrators.

According to one embodiment, in the TDU, the heating wire, which is coiled around the tube, may be electrically connected to an electrical power source. When the electrical power source applies electrical power to the heating wire, the heating wire may generate heat rapidly. The TDU may have a relatively low thermal mass and a high heating efficiency. As a result, the tube and the adsorbent material disposed inside the tube may be heated rapidly. For example, the adsorbent material may be heated up to 270° C. within 0.3 seconds. Consequently, the adsorbent material disposed inside the tube may release the collected volatile organic compounds in a relatively short amount of time, such as, in less than 0.5 seconds.

Traditionally, a GC system may include a column part that separates a fluid sample. When the fluid sample to be analyzed enters the column part, the column part is heated by a traditional oven to increase temperature. This increase in temperature causes the fluid sample to separate into various fluid components. The fluid components may then successively emerge from the column part and enter a detector. However, the oven is usually large in size, making the column part unsuitable for use in a miniaturized, portable gas analytical system, such as a micro gas chromatography (GC) system.

In addition, the column part includes a capillary column which is configured to separate a targeted compound (e.g., a fluid sample) for a targeted application. When the application of the column part changes and the targeted compound changes to a different targeted compound, the capillary column needs to be replaced with a new capillary column configured to separate the different targeted compound. Because of the small dimension of the capillary column, the capillary column is fragile and not suitable for being handled. These factors make it difficult to replace the capillary column.

Embodiments of the present disclosure address one or more disadvantages associated with the above-described column part. According to one embodiment, a column module may include a capillary column and a heating wire coiled around the capillary column. The heating wire may be supplied with electrical power to heat the capillary column. In this manner, the traditional oven may be removed to save space and power consumption, without compromising the temperature control capability, making the column module suitable for use in a GC system, especially in a portable GC system.

According to one embodiment, the column module may include a case that encloses the capillary column. The case may be formed with standard connectors to be connected to other components in a GC system. The standard connectors may be commercially available connectors that are commonly used in GC systems or other gas analytic systems. The standard connectors may include standard gas flow connectors that fit most component in the GC system. When the capillary column needs to be replaced for a different application, the capillary column does not require direct handling. Instead, the standard connectors may be disconnected from other components in the GC system, and the entire column module may be replaced with a different column module. As a result, it is easy to replace the column module with one designed for different targeted compounds. In addition, the case may protect the capillary column, making the column module a reliable unit.

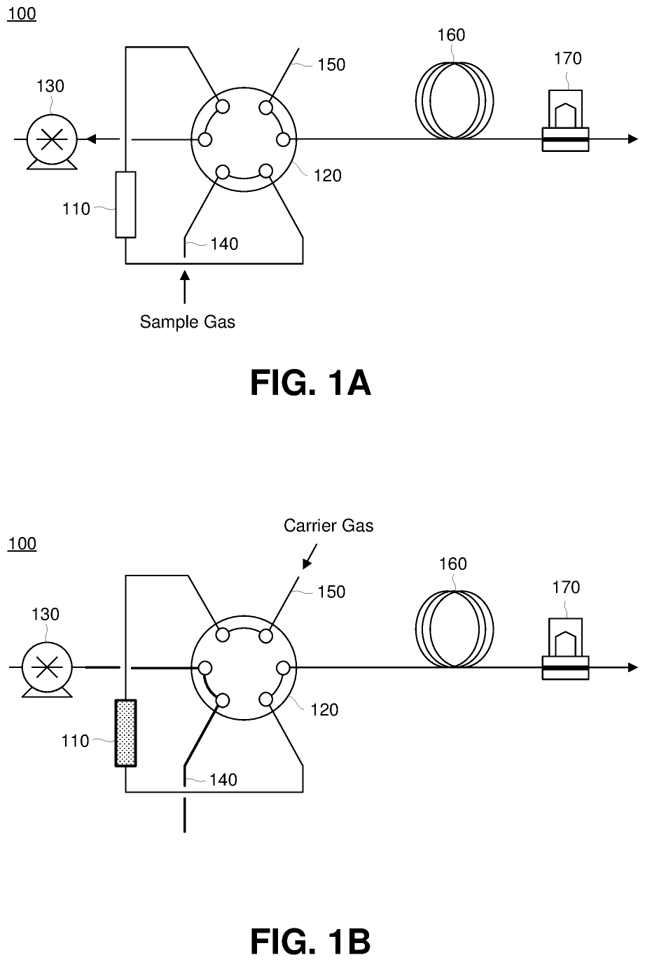

FIGS. 1A and 1B are schematic illustrations of a gas chromatograph (GC) system 100, according to one embodiment of the present disclosure. FIG. 1A illustrates the GC system 100 when it is performing a sampling operation, according to one embodiment of the present disclosure. FIG. 1B illustrates the GC system 100 when it is performing an analyzing operation, according to one embodiment of the present disclosure.

As shown in FIGS. 1A and 1B, the GC system 100 may include a thermal desorption unit (TDU) 110 (which may also be referred to as a “preconcentrator”), a six-port valve 120, a pump 130, a sample inlet 140, a carrier gas inlet 150, a column module 160, and a photoionization detector 170. The sample inlet 140 may be used to introduce a fluid sample into the GC system 100. The fluid sample may include gases, vapors, liquids, and the like. For example, the fluid sample may be volatile organic compounds (VOCs). The carrier gas inlet 150 may be used to introduce a carrier gas into the GC system 100. For example, the carrier gas may be an inert gas.

In the embodiment shown in FIG. 1A, during the sampling operation, the six-port valve 120 may be configured to connect the thermal desorption unit 110 with the pump 130 and the sample inlet 140, and to disconnect the TDU 110 from the carrier gas inlet 150 and the column module 160. When the pump 130 starts pumping, a fluid sample may enter the TDU 110 through the sample inlet 140. The TDU 110 may collect and concentrate the fluid sample.

In the embodiment shown in FIG. 1B, during the analyzing operation, the six-port valve 120 may be configured to connect the TDU 110 with the carrier gas inlet 150 and the column module 160, and to disconnect the TDU 110 from the pump 130 and the sample inlet 140. A carrier gas may be introduced into the TDU 110 through the carrier gas inlet 150. The carrier gas may carry the fluid sample collected in the TDU 110 into the column module 160. The column module 160 may separate the fluid sample into various fluid components having different retention times. The fluid components may then successively emerge from the column module 160 and enter the PID 170 according to their respective retention times.

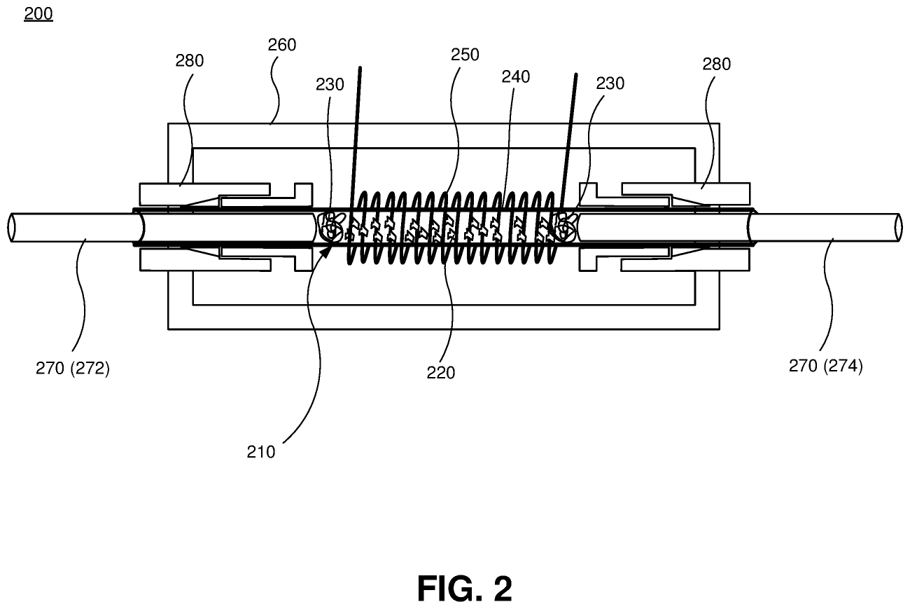

Descriptions related to a thermal desorption unit (TDU) according to embodiments of the present disclosure will be provided below with reference to FIGS. 2-6.

FIG. 2 is a schematic illustration of a thermal desorption unit (TDU) 200, according to some embodiments of the present disclosure. The TDU 200 may be an example implementation of the TDU 110 included in the GC system 100 in the embodiment illustrated in FIGS. 1A and 1B.

As shown in FIG. 2, the TDU 200 may include a tube 210, an adsorbent material 220 disposed inside the tube 210, holding members 230 disposed inside the tube 210 and at opposite ends of the adsorbent material 220, an electrical insulating layer 240 disposed on an external surface of the tube 210, a heating wire 250 coiled around the tube 210, a housing 260 defining an inner space where the tube 210 is disposed, and two gas flow columns 270 coupled to opposite ends of the tube 210. For example, the tube 210 may include a first opening and a second opening at opposite ends of the tube 210, and the two gas flow columns 270 may include a first gas flow column 272 and a second gas flow column 274. The first gas flow column 272 and the second gas flow column 274 may be inserted into the first and second openings of the tube 210, respectively. Two connectors 280 may be disposed around the opposite ends of the tube 210 to seal the opposite ends of the tube 210 with the respective gas flow columns 270, such that no gas will leak from the tube 210.

When a fluid sample enters the TDU 200 via the first gas flow column 272, the adsorbent material 220 may adsorb the fluid sample. When an electric power is applied to the heating wire 250, the heating wire 250 may generate heat along the tube 210 to heat the tube 210 and the adsorbent material 220 contained in the tube 210. As a result, the adsorbent material 220 may desorb the fluid sample, and release the fluid sample through the second gas flow column 274.

The tube 210 may be formed of a heat conductive and corrosion resistive material. In one embodiment, the tube 210 may be formed of stainless steel. The tube 210 may be configured to have an inner diameter slightly larger than an outer diameter of the gas flow columns 270 in order to achieve gas-tight sealing and minimum dead volume. The tube 210 may be configured to have a relatively thin wall in order to achieve fast thermal conduction. In one embodiment, the tube 210 may have an inner diameter (ID) of 0.58 mm and an outer diameter (OD) of 0.81 mm.

The adsorbent material 220 may be disposed inside the tube 210. The adsorbent material 220 may include one material or a combination of several materials that are capable of adsorbing a fluid sample (e.g., VOC) at a room temperature and desorbing the fluid sample at a high temperature. In some embodiments, the adsorbent material 220 may be formed as adsorbent beads. In addition, the adsorbent material 220 may be a commercially available adsorbent material, such as activated carbon, carbon black, carbon molecular sieve, etc. For example, the adsorbent material 220 may be Carbopack X provided by Supelco, or Tenax TA™.

The holding members 230 may be disposed inside the tube 210 and at opposite ends of the adsorbent material 220, respectively. That is, the holding members 230 may include a first member disposed at a first end of the adsorbent material 220 and a second member disposed at a second end of the adsorbent material 220. The holding members 230 may be configured to hold the adsorbent material 220 in the tube 210 and prevent the adsorbent material 220 from entering the gas flow columns 270. In one embodiment, the holding member 230 may be glass wool.

The electrical insulating layer 240 may be disposed on the external surface of the tube 210 between the tube 210 and the heating wire 250. The electrical insulating layer 240 may be formed of an electrical insulating material. When the tube 210 is formed of stainless steel, if the electrical insulating layer 240 is not present between the stainless steel tube 210 and the heating wire 250, a short circuit might occur between the stainless steel tube 210 and the heating wire 250. In contrast, in the embodiments of the present disclosure, the electrical insulating layer 240 may electrically separate the stainless steel tube 210 and the heating wire 250, thus preventing a short circuit between the stainless steel tube 210 and the heating wire 250. In some embodiments, the electrical insulating material for forming the electrical insulating layer 240 may be ceramic adhesive, which may be coated on the external surface of the tube 210.

The heating wire 250 may be coiled around the tube 210. The heating wire 250 may be a resistance heating wire electrically connected to an external electrical power source. When the external electrical power source supplies an electrical power to the heating wire 250, the heating wire 250 may generate heat along the tube 210 and heat the tube 210 and the adsorbent material 220 disposed inside the tube 210. If a fluid sample is adsorbed in the adsorbent material 220, the adsorbent material 220 may desorb the fluid sample and release the fluid sample through the second gas flow column 274. For example, the heating wire 250 may be a commercially available product, such as Nichrome 80 resistance wire provided by K.Bee Vapor. The Nichrome 80 resistance wire is comprised of 80% Nickel and 20% Chromium, and has a diameter of 0.51 mm.

In an alternative embodiment, the heating wire 250 may be formed with an electrical insulating layer on its external surface. In this case, the heating wire 250 may be directly coiled around the tube 210 without the electrical insulating layer 240 disposed between the tube 210 and the heating wire 250.

The housing 260 may be configured to enclose the tube 210. The housing 260 may be formed of a metal, such as, for example, aluminum (Al). The housing 260 may have any shape and any size that provides an inner space in which tube 210 can be disposed. In one embodiment, the housing 260 may be a right prism (e.g., a square prism) or a cylinder extending in a direction parallel with an extending direction of the tube 210. The housing 260 may include through holes. End portions of heating wire 250 may extend through the through holes and connect heating wire 250 with an external electrical power source. In addition, the housing 260 may include opening at opposite ends and the gas flow columns 270 may extend through the openings and connect to other components in a GC system.

The two gas flow columns 270, including the first gas flow column 272 and the second gas flow column 274, may be configured to fluidly connect the tube 210 with other components in a GC system (e.g., the GC system 100 illustrated in FIGS. 1A and 1B) in order to transfer a fluid sample into and out of the tube 210. For example, during a sampling operation of the GC system, the first gas flow column 272 may be connected between the tube 210 and a sample inlet (e.g., the sample inlet 140 in the GC system 100) to transfer a fluid sample from the sample inlet into the tube 210. In addition, during the sampling operation of the GC system, the second gas flow column 274 may be connected between the tube 210 and a pump (e.g., the pump 130 in the GC system 100), to transfer the fluid sample from the tube 210 to the pump. The gas flow columns 270 (272 and 274) may be formed of stainless steel and may be inserted into two opposite openings of the tube 210, respectively. In some embodiments, the inner surface of the gas flow columns 270 may be treated or coated with a layer to prevent a reaction between the fluid sample with the stainless steel gas flow columns 270. For example, the gas flow columns 270 may be formed of a commercially available GC metal column, such as a Hydroguard-Treated MXT Guard/Retention Gap Column provided by Restek. The gas flow columns 270 may have an inner diameter (ID) of 0.28 mm and an outer diameter (OD) of 0.56 mm.

The two connectors 280 may be disposed around opposite ends of the tube 210, respectively, to connect and tightly seal a gap between the tube 210 and the gas flow columns 270. In some embodiments, each one of the connectors 280 may be a commercially available internal union connector that includes three parts: a body, a nut, and a ferrule. An inner diameter (ID) of the internal union connector may be larger (e.g., slightly larger) than an outer dimeter of the tube 210. For example, the ID of the internal union connector may be 0.82 mm. The connectors 280 may have any other appropriate structure as long as they can seal the gap between the tube 210 and the gas flow columns 270 such that no fluid leaks out of the tube 210. The present disclosure does not limit the structure of the connectors 280.

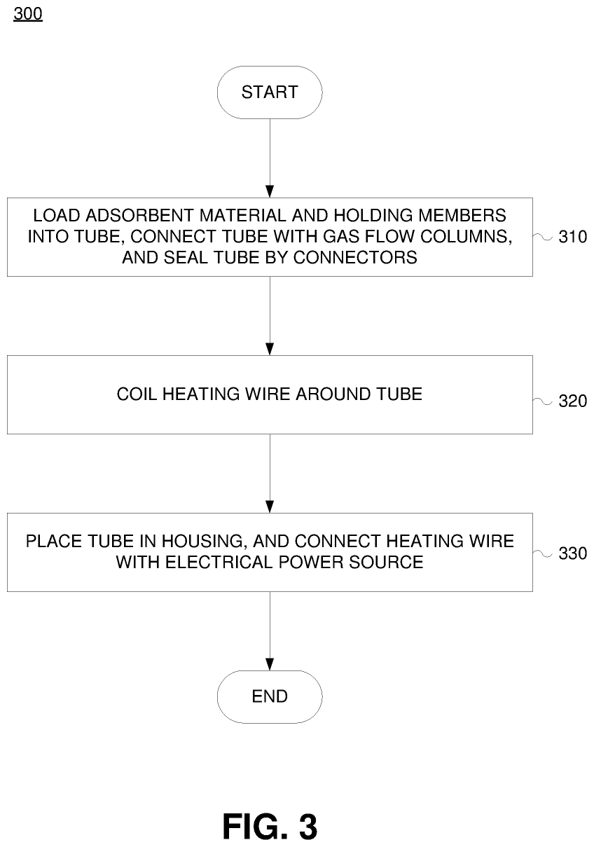

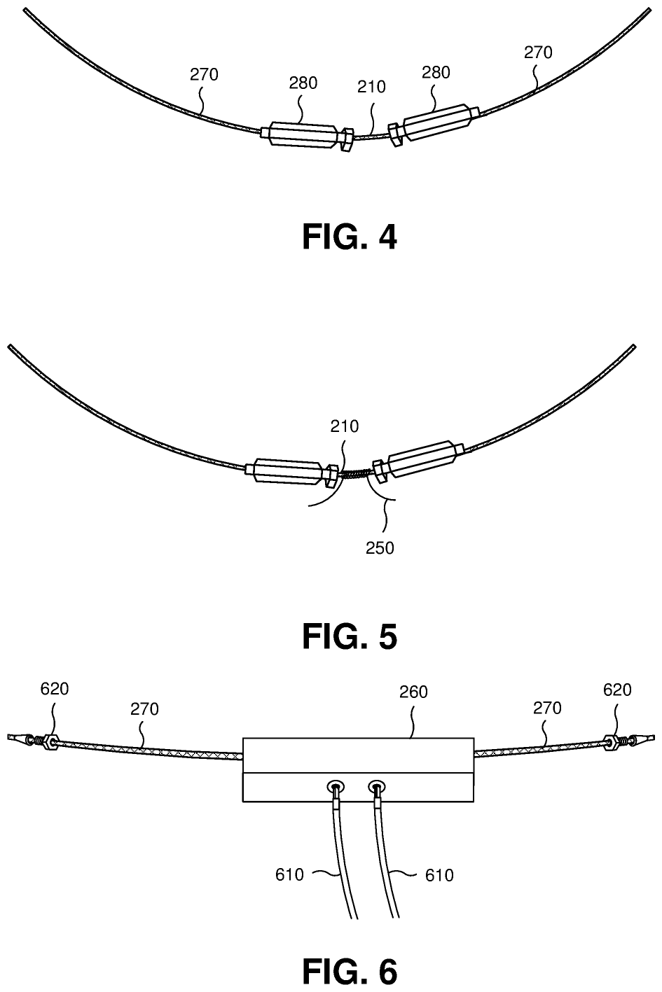

FIG. 3 is a flow chart of a method 300 of assembling the TDU 200 illustrated in FIG. 2, according to some embodiments of the present disclosure. FIGS. 4, 5, and 6 are images of an exemplary TDU during various stages of assembly, according to some embodiments of the present disclosure.

As shown in FIG. 3, in step 310, the adsorbent material 220 and the holding members 230 may be loaded into the tube 210. Next, the tube 210 loaded with the adsorbent material 220 and the holding members 230 may be connected with the gas flow columns 270. Then, the tube 210 may be sealed by the connectors 280. FIG. 4 is a schematic illustration showing the tube 210 connected with two columns 270 at opposite ends of the tube 210, and that the tube 210 is sealed by two connectors 280.

Referring back to FIG. 3, in step 320, an external surface of the tube 210 may be coated with the electrical insulating layer 240, and then the heating wire 250 may be coiled around the tube 210. FIG. 5 is a schematic illustration showing the tube 210 in FIG. 4 coiled with the heating wire 250.

In an alternative embodiment, the heating wire 250 may be formed with an electrical insulating layer on its external surface. In this case, heating wire 250 may be directly coiled around the tube 210 without the electrical insulating layer 240 disposed between the tube 210 and the heating wire 250. Thus, in this case, step 320 may only include coiling the heating wire 250 around the tube 210.

Referring back to FIG. 3, in step 330, the tube 210 coiled with the heating wire 250 and connected with the gas flow columns 270 may be placed in the housing 260. End portions of the heating wire 250 may extend through the through holes formed on the housing 260 and may be connected to the electrical power source via power cables 610. In addition, end portions of the gas flow columns 270 may extend through the openings formed at opposite ends of the housing 260. The end portions may be connected with nuts and ferrules 620 in order to connect the end portions to other components in a GC system. FIG. 6 is a schematic illustration showing a housing in which the tube in FIG. 5 is disposed.

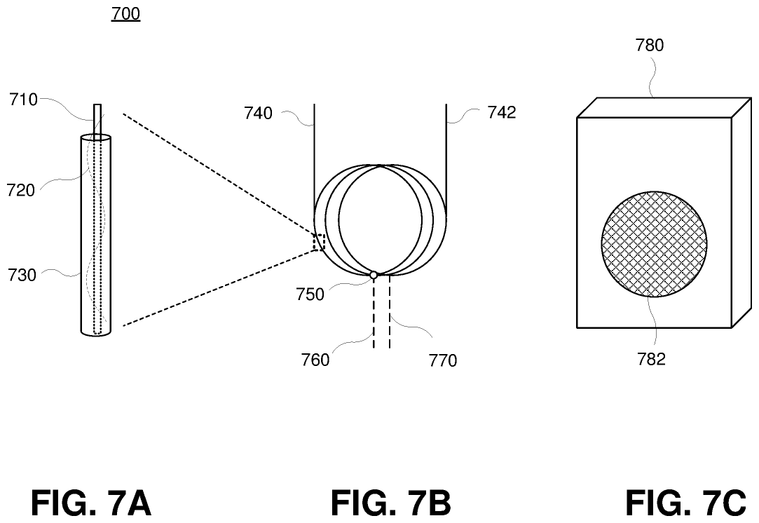

Descriptions related to a column module according to embodiments of the present disclosure will be provided below with reference to FIGS. 7-9.

FIGS. 7A, 7B, and 7C are schematic illustrations of a column module 700, according to some embodiments of the present disclosure. FIG. 7B is a schematic illustration of certain components of the column module 700. FIG. 7A is an enlarged schematic illustration of a portion of the column module 700. FIG. 7C is a schematic illustration of a case of the column module 700. The column module 700 may be an example implementation of the column module 160 included in the GC system 100 in the embodiment illustrated in FIGS. 1A and 1B.

As shown in FIG. 7, the column module 700 includes a capillary column 710, a heating wire 720, an electrical insulating layer 730, a gas inlet 740, a gas outlet 742, a temperature sensor 750, one or more sensor cables 760, one or more power cables 770, and a case 780.

A fluid sample carried by a carrier gas may be introduced into the capillary column 710 via the gas inlet 740. As the fluid sample traverses the capillary column 710, the fluid sample may be separated into various fluid components having different retention times. The fluid components may then successively emerge from the capillary column 710 according to their respective retention times.

The capillary column 710 may be configured to separate the fluid sample into various fluid components having different retention times. An inner surface of the capillary column 710 may be coated with a thin coating layer, and a chemical reaction may occur between the fluid sample and the coating layer. The length of the capillary column 710 may be from 0.1 m to 30 m. The inner diameter (ID) of the capillary column 710 may be from 0.15 mm to 0.53 mm. The thickness (df) of the coating layer may be from 0.1 μm to 10.0 μm. For example, the capillary column 710 may be formed from a Rtx-VMS column provided by Restek, the length of the capillary column 710 may be 6 m, the inner diameter of the capillary column 710 may be 0.25 mm, and the thickness (df) of the coating layer may be 1.4 μm. The column type, length, ID, and df may be determined by many factors including targeted compounds, concentrations, interference compounds, analysis time, and so on, and the present disclosure is not limited to the example described above.

The heating wire 720 may be coiled around an outer surface of the capillary column 710. In some embodiments, the heating wire 720 may be coiled around the entire length of the capillary column 710. In some alternative embodiments, the heating wire 720 may be coiled around a portion of the capillary column 710. The heating wire 720 may be connected to an external power source via the power cables 770. The external power source may be controlled by a temperature controller to supply electric power to the heating wire 720. The temperature controller may execute a preset heating program to control the power source to supply desired power, such that the heating wire 720 may heat the capillary column 710 to reach a desired temperature. The heating wire 720 may be formed of a resistance heating wire. For example, the heating wire 720 may be formed of Ni200 tempered Nickel wire (32 AWG).

The electrical insulating layer 730 may formed around the capillary column 710 and the heating wire 720. Due to the limited space in a GC system, the combination of the capillary column 710, the heating wire 720 coiled around the outer surface of the capillary column 710, and the electrical insulating layer 730 formed around the capillary column 710 and the heating wire 720, may be wound in several turns to form an assembly. Since there are many rounds of the capillary column 710 and the heating wire 720 wound together, if the electrical insulating layer 730 is not present, a short circuit may occur between different sections of the heating wire 720. Thus, the electrical insulating layer 730 prevents a short circuit between different sections of the heating wire 720.

The gas inlet 740 and gas outlet 742 may be disposed at opposite ends of the capillary column 710, respectively. The gas inlet 740 and gas outlet 742 may be configured to connect the capillary column 710 to other components in a GC system (e.g., the GC system 100 illustrated in FIGS. 1A and 1B) and allow the fluid sample pass through the capillary column 710 to be separated. For example, the gas inlet 740 may be connected to a valve (e.g., the six-port valve 120 in the GC system 100), and the gas outlet 742 may be connected to a detector (e.g., the photoionization detector 170 in the GC system 100).

The temperature sensor 750 may be disposed contiguous to an outer surface portion of the assembly formed by winding the capillary column 710, the heating wire 720, and the electrical insulating layer 730 together. The temperature sensor 750 may be configured to measure the temperature of the capillary column 710. The temperature sensor 750 may be formed of various type of sensors, such as a thermal couple, a thermistor, and a resistance temperature sensor. For example, the temperature sensor 750 may be formed of a K type thermal couple. The temperature sensor 750 may generate a temperature signal representing the temperature of the capillary column 710 and may transmit the temperature signal to the temperature controller via the sensor cables 760. Based on the temperature signal, the temperature controller may execute a preset heating program to control the external power source to supply the desired electrical power to the heating wire 720 via the power cables 770, such that the heating wire 720 may heat the capillary column 710 to reach a desired temperature.

In some embodiments, after the assembly including the capillary column 710, the heating wire 720, and the electrical insulating layer 730 is wound together, and the temperature sensor 750 is disposed adjacent to the assembly, a thermal conductive layer, such as an Aluminum foil or tape, may be wrapped around the assembly and the temperature sensor 750 to fix the assembly and the temperature sensor 750, to improve the temperature uniformity, thus forming a composite assembly.

The case 780 may enclose the composite assembly to provide protection to the composite assembly. The case 780 may be formed in various shapes and sizes depending on the actual application of the column module 700. The case 780 may be formed with one or more cooling holes 782 to release the heat of the column module 700 to the outside of the case 780 during a cooling step. An external cooling fan may be directly attached onto the case 780 or may be installed close to the cooling holes 782.

Although not shown in FIGS. 7A, 7B, and 7C, the case 780 may be formed with a thermal insulating layer on an inner surface of the case 780. The thermal insulating layer may be configured to maintain the heat of the column module 700 during a heating step, thus saving energy.

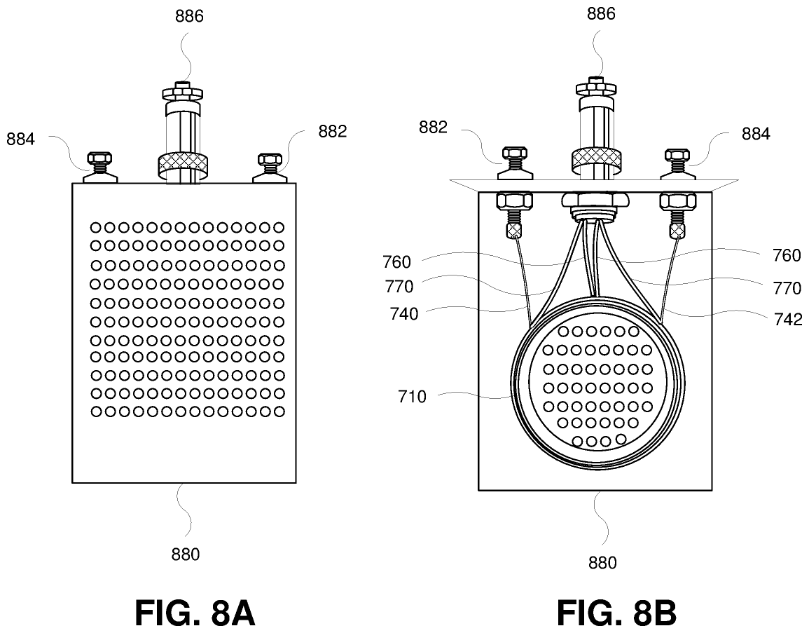

FIGS. 8A and 8B are schematic illustrations of a column module 800 in an assembled state, according to some embodiments of the present disclosure. FIG. 8A illustrates a front view of an exterior of the column module 800. FIG. 8B illustrates a front view of an interior of the column module 800.

The column module 800 in the embodiment illustrated in FIGS. 8A and 8B may include various components of the column module 700 illustrated in FIGS. 7A-7C, including the capillary column 710, the heating wire 720, the electrical insulating layer 730, the gas inlet 740, the gas outlet 742, the temperature sensor 750, the sensor cables 760, and the power cables 770. The properties and the arrangement of these components may be the same as those in the embodiment illustrated in FIGS. 7A-7C. Therefore, detailed descriptions of these components are not repeated here.

In the embodiment illustrated in FIGS. 8A and 8B, the column module 800 may further include a case 880 that encloses the above-mentioned components, including the capillary column 710, the heating wire 720, the electrical insulating layer 730, the gas inlet 740, the gas outlet 742, the temperature sensor 750, the sensor cables 760, and the power cables 770.

The case 880 may be formed with standard connectors connected with the gas inlet 740, the gas outlet 742, the sensor cables 760, and the power cables 770. The standard connectors may be configured to connect various components of the column module 700 to a power source, a controller, and other components, in a GC system, thus allowing for quick installation and replacement of the column module 700. Specifically, the case 880 may be formed with a first gas flow connector 882 connected with the gas inlet 740, a second gas flow connector 884 connected with the gas outlet 742, and a temperature control connector 886 connected with the sensor cables 760 and the power cables 770. The first gas flow connector 882 may be connected to a component in a GC system that is upstream to the column module 800 (e.g., the six-port valve 120 in the GC system 100). The second gas flow connector 884 may be connected to a component in a GC system that is downstream to the column module 800 (e.g., the photoionization detector 170 in the GC system 100). The temperature control connector 886 may be connected to an external temperature controller.

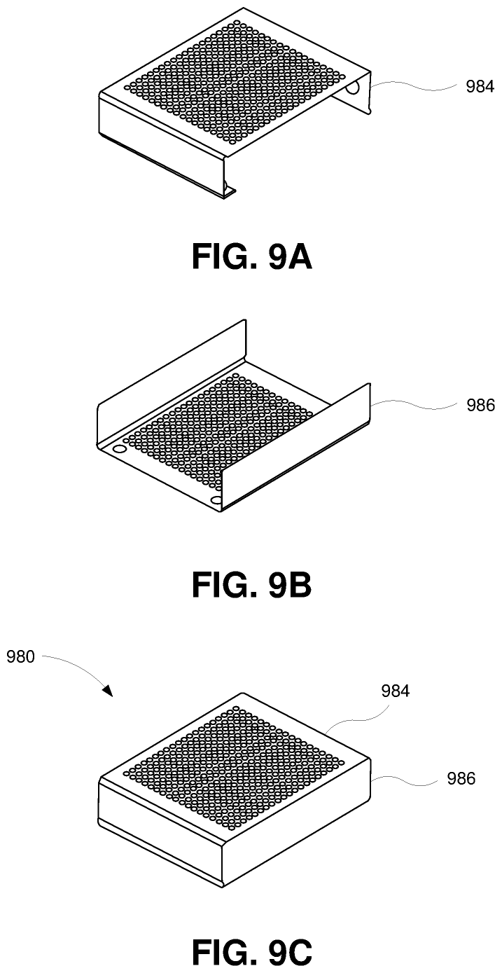

In some embodiments, the case may be formed in two pieces and may be assembled when other components are disposed inside the case. FIGS. 9A, 9B, and 9C are schematic illustrations of a two-piece case 980 of a column module, according to such an embodiment of the present disclosure. FIG. 9A illustrates a perspective view of a base part 984 of the case 980. FIG. 9B illustrates a perspective view of a shield part 986 of the case. FIG. 9C illustrates a perspective view of the case 980 when the base part 984 and the shield part 986 are assembled together.

While illustrative embodiments have been described herein, the scope of the present disclosure covers any and all embodiments having equivalent elements, modifications, omissions, combinations (e.g., of aspects across various embodiments), adaptations and/or alterations as would be appreciated by those skilled in the art based on the present disclosure. For example, features included in different embodiments shown in different figures may be combined. The limitations in the claims are to be interpreted broadly based on the language employed in the claims and not limited to examples described in the present specification or during the prosecution of the application. The examples are to be construed as non-exclusive. It is intended, therefore, that the specification and examples be considered as illustrative only, with a true scope and spirit being indicated by the following claims and their full scope of equivalents.

What is claimed is:

1. A thermal desorption unit, comprising:
a tube;
an adsorbent material including one material or a combination of several materials disposed inside the tube;
holding members disposed inside the tube and configured to hold the adsorbent material in the tube; and
a heating wire coiled around the tube and configured to generate heat along the tube.

2. The thermal desorption unit of claim 1, wherein the tube includes two opening at opposite ends of the tube, and
the thermal desorption unit further comprises:
two gas flow columns coupled to opposite ends of the tube, respectively; and
two connectors disposed around the opposite ends of the tube, respectively, to seal the opposite ends of the tube with the gas flow columns.

3. The thermal desorption unit of claim 2, wherein the gas flow columns are formed of stainless steel.

4. The thermal desorption unit of claim 1, wherein the tube is formed of stainless steel.

5. The thermal desorption unit of claim 1, wherein the heating wire is a resistance heating wire.

6. The thermal desorption unit of claim 1, wherein the holding members are disposed at opposite ends of the adsorbent material.

7. The thermal desorption unit of claim 6, wherein the holding members are formed of glass wool.

8. The thermal desorption unit of claim 1, further comprising:
an electrical insulating layer disposed on an external surface of the tube.

9. The thermal desorption unit of claim 8, wherein the electrical insulating layer is formed of ceramic adhesive.

10. The thermal desorption unit of claim 1, further comprising:
a housing that encloses the tube.

11. The thermal desorption unit of claim 1, wherein the tube comprises a first opening and a second opening disposed at opposite ends of the tube,
the adsorbent material being configured to adsorb a fluid sample received through the first opening, and release the fluid sample through the second opening when heated by the heating wire.

12. A gas chromatography system comprising the thermal desorption unit of claim 1.

13. A column module, comprising:
a capillary column;
a heating wire coiled around the capillary column;
a temperature sensor configured to monitor the temperature of the capillary column; and
an electrical insulating layer disposed around the capillary column and the heating wire.

14. The column module of claim 13, wherein a combination of the capillary column, the heating wire, and the electrical insulating layer are wound to form an assembly.

15. The column module of claim 13, further comprising:
a thermal conductive layer formed around the assembly.

16. The column module of claim 15, further comprising:
a case that encloses the assembly and the thermal conductive layer.

17. The column module of claim 16, wherein the temperature sensor is disposed contiguous to an outer surface of the assembly.

18. The column module of claim 17, wherein the case is formed with connectors connected to openings of the capillary column, the heating wire, and the temperature sensor.

19. The column module of claim 16, wherein the case is formed with cooling holes and a thermal insulating layer.

20. A gas chromatography system comprising the column module of claim 13.
